(19) United States
(12) Patent Application Publication
(10) Pub. No.: US 2022/0098901 A1
(43) Pub. Date: Mar. 31, 2022

(54) LOCK SYSTEM WITH REDUNDANT KEY LOCK MECHANISM

(71) Applicant: MG TECH CENTER BV H.O.D.N. LOCK TECHNOLOGY, ULFT (NL)

(72) Inventor: Klaus W. Gartner, Palos Verdes Estates, CA (US)

(21) Appl. No.: 17/034,439

(22) Filed: Sep. 28, 2020

(51) Int. Cl. E05B 47/06; E05B 65/00; E05B 17/20; G07C 9/33

(52) U.S. Cl. CPC E05B 47/0607; E05B 65/0075; E05B 2047/0084; G07C 9/33; E05B 17/2034

(57) ABSTRACT

A lock system having a redundant entry system is provided. The lock system includes a container having a door with an inner wall and an outer wall defining a wall volume therebetween; a locking bolt including a tip; a housing mounted to the inner wall, the housing for receiving the locking bolt, the locking bolt movable between a blocking position and a non-blocking position; a post mounted on the inner wall; a bolt works having an elongate slot there on, the elongate slot slidingly received by the post and configured to allow the bolt works to move between a locked position and an unlocked position.

### FIELD OF THE INVENTION

The present invention relates generally to a lock that can be opened by either electronic means by entering a code into a keypad or by manual means such as using a key.

### BACKGROUND OF THE INVENTION

Safes and other secure containers have traditionally used combination locks for controlling and authorizing entry. Early locks were entirely mechanical and relied on a person dialing a correct combination on a rotating dial. Rotation of the dial positioned mechanical elements within the lock such that dialing the correct combination allowed a locking bolt to release the container door. Proper dial rotation aligned gates in tumblers. Once the gates were aligned, a fence on a fence lever entered the aligned gates. Continued rotation of the dial and tumblers pulled the fence lever and withdrew the bolt.

However, over the years electromechanical locks have gradually replaced the mechanical locks described above. Indeed, electromechanical locks themselves have seen many improvements over the years. The use of sophisticated electronic logic circuitry has enabled the implementation of a series of complex and unique electronic combinations which has made improper entry into secured areas more difficult. When the lock is used to secure entry to a container, the electronic components are typically mounted within a housing inside the container door. The housing contains an actuating device and a circuit board. The electronic key pad transmits a signal to the circuit board, which contains the electronic circuitry that allows the lock to open and close. The keypad is located on the outside of the housing so as to be accessible to the user. A cable typically extends between the keypad and the circuit board for transmitting signals between the two components.

In addition to the electronic circuitry, electromechanical locks include a bolt. The bolt is movably constructed and is coupled to a bolt-displacing device enabling a user to selectively move the bolt into one of at least two end positions by means of the actuating device. The lock is blocked and therefore “locked” in a first end position of the bolt and unblocked or “open” and “unlocked” in a second end position of the bolt. When the user enters the correct combination into an electronic keypad, a signal is transmitted to the circuit board. The circuit board in turn actuates the actuating device, which allows the locking bolt to move to the unlocked position within the housing, thus allowing the user to open the safe door.

Although known electronic locks have proven effective in everyday practical use, there is a need for improvement, particularly with regard to design. For example, electrical surges in the power line supplying power to the electronic lock can damage the circuitry making impossible the opening of the lock by using the authorized code input into the keypad. The resultant cost to have the safe or secured area opened could be significant in light of the materials used for the enclosure and the difficulty in gaining entry by cutting through those materials. In addition, malfunction could also result from tampering, or loss of power making opening of the lock impossible.

In addition, an owner may want to have the lock serviced and not want to provide the access code to the service person but rather use the key for entry.

Accordingly, there is a need for a lock that can be opened by either electronic means by entering a code into a keypad or by manual means such as using a key.

### BRIEF SUMMARY OF THE INVENTION

The problems outlined above are addressed by the lock system in accordance with the invention. The lock system in accordance with the invention provides for a manual/mechanical means to open a lock, such as a key, and an electronic means for opening the lock such as entering an authorized code into an electronic keypad. The manual mechanical means is mounted on the container/safe and hidden behind the electronic key pad which is on a dial. The dial is mounted outside the container to be protected.

The dial includes a key pad having a series of electronic numbers, typically from 1-9 and 0 which, when contacted by a user entering the correct combination, will generate an electronic signal to rotary means.

The manual mode of opening of the lock includes a keyed entry system that accommodates a key for unlocking the lock system.

In one aspect, the lock system in accordance with the invention includes a container having a door with an inner wall and an outer wall defining a wall volume therebetween; a locking bolt including a tip; a housing mounted to the inner wall, the housing for receiving the locking bolt, the locking bolt movable between a blocking position and a non-blocking position; a post mounted on the inner wall; bolt works slidingly received by the post and moveable between a locked position and an unlocked position, wherein in the blocking position, the tip of the locking bolt contacts the bolt works and blocks it from moving and in the non-blocking position the locking bolt retracts into the housing and allows the bolt works to move from the locked position to the unlocked position.

In another aspect of the invention the bolt works is substantially L-shaped in cross section and includes a bolt works body and a downwardly extending flange. The flange contacts the inner wall of the container door and moveably slides from a locked position to an unlocked position.

These and other features of the invention will now be disclosed in detail.

### BRIEF DESCRIPTION OF THE DRAWINGS

For a better understanding of the invention, and to show how the same may be carried into effect, reference will now be made, by way of example, to the accompanying drawings, in which:

FIG. 1 depicts an electronic dial having a key pad mounted to a container to be secured.

FIG. 2 depicts a keyed entry system mounted to the container and positioned behind the electronic key pad.

FIG. 3 is a perspective view of the lock system in accordance with the invention with the bolt works removed for clarity.

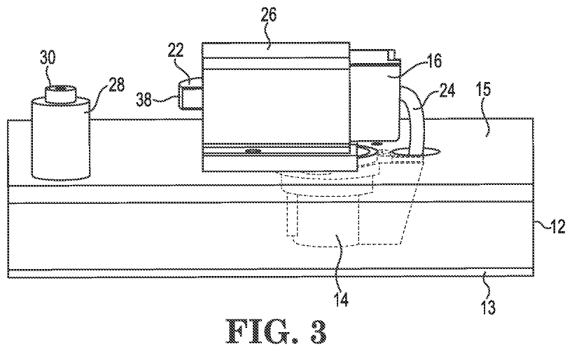

FIG. 4 is a perspective view of the lock system in accordance with the invention showing detail thereof with the bolt works removed for clarity.

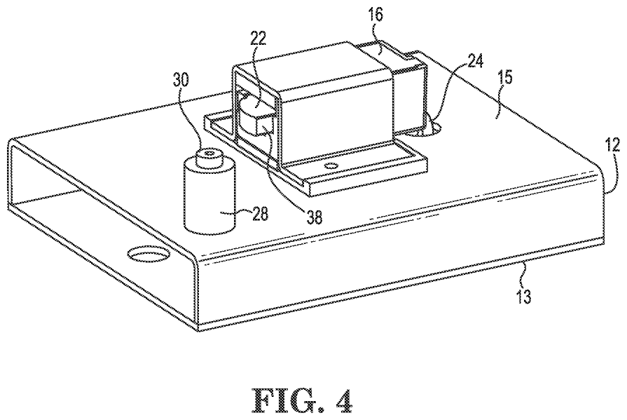

FIG. 5 is a top view of the lock system in accordance with the invention showing the locking bolt in the blocking position and the bolt works in the locked position.

FIG. 6 is a top view of the lock system in accordance with the invention showing the locking bolt in the non-blocking position retracted into the housing and the bolt works ready to be moved into the unlocked position.

FIG. 7 is a top view of the lock system in accordance with the invention showing the bolt works moved to the unlocked position.

### DETAILED DESCRIPTION OF THE INVENTION

Bolt locking devices mount a bolt for moving between locked and unlocked positions. This application refers to the bolt within the locking device as the “locking bolt.” The locking bolt moves between a blocking position and a non-blocking position. The mechanism that secures the safe door to the rest of the safe are called “bolt works.” The bolt works moves between a locked position and an unlocked position.

When the locking bolt is in the blocking position it maintains the bolt works in the locked position. When the locking bolt in in the non-blocking position it allows the bolt works to move from the locked position to the unlocked position allowing a user to access the container.

In general, a handle on the outside of the safe connects to the bolt works. Rotating the handle initiates movement of the bolt works. If the user enters the correct combination or inserts a key into a keyed cylinder, the locking bolt retracts into a housing. This retraction or non-blocking position in turn permits the bolt works to move an unlocked position that allows an operator to open the safe door.

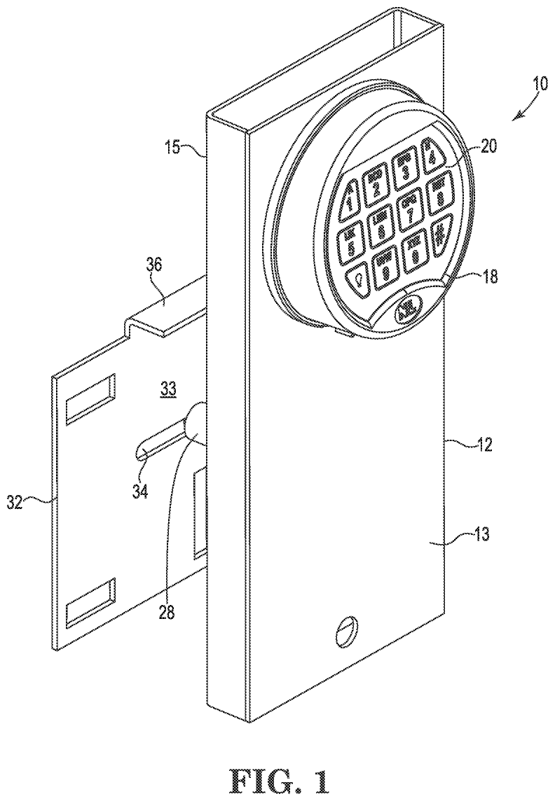

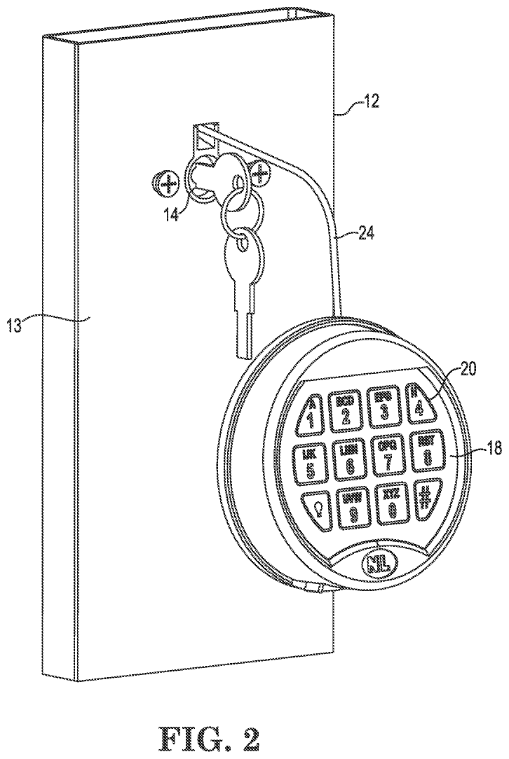

Referring now to FIG. 1 the redundant key lock system 10 in accordance with the invention is shown. The redundant key lock system 10 is mounted to a wall 12, which is representative of the door of a container, a safe or security room, or portions of a wall adjacent to such doors. Wall 12 includes outer wall 13 and inner wall 15. The redundant key lock system 10 in accordance with the invention provides for a manual/mechanical means to open a lock, such as a keyed entry, mounted on the wall 12 (as best seen in FIG. 2) and an electronic means 16 for opening the lock such as a user entering an authorized code into a dial 18 having an electronic keypad 20 (as best seen in FIG. 1). As best seen in FIG. 2, the manual mechanical keyed entry means 14 is mounted on the container/safe and hidden behind the electronic key pad 20 and dial, which is mounted outside the container to be protected.

The key pad 20 includes a series of electronic numbers, typically from 1-9 and 0 which, when contacted by a user entering an authorized combination, will generate an electronic signal to locking bolt 22 through cable 24 via electronic means 16. Housing 26 houses locking bolt 22 and electronic means 16. When a user enters an authorized combination electronic means 16 sends an electronic signal to locking bolt 22 which moves from a blocking position to a non-blocking position. When locking bolt 22 retracts to the non-blocking position, it allows bolt works 32 to move an unlocked position that allows an operator to open the safe door. Locking bolt 22 may be a rotary locking bolt.

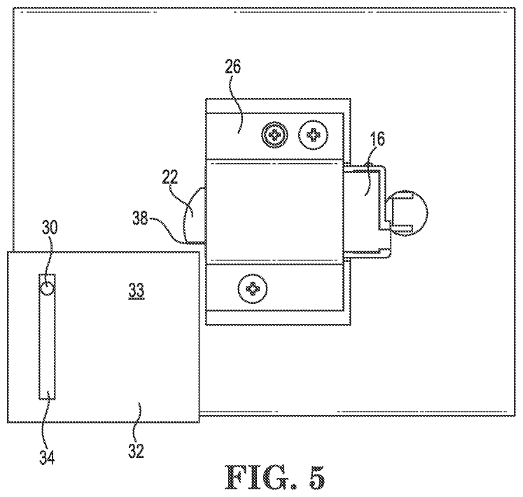

Elongate post 28 is mounted on the inside container wall 15 and includes a collar 30 projecting radially therefrom. The outer diameter of post 28 is larger than the outer diameter of collar 30 thus making collar project therefrom. Bolt works 32 is substantially L-shaped in cross section (as best seen in FIG. 1) and includes bolt works body 33, elongate slot 34 and flange 36. Elongate slot 34 extends along a length thereof and slidingly receives collar 30. Elongate slot 34 has a width that is larger than the outer diameter of collar 30 that allows collar 30 to moveably slide within slot 34. The width of slot 34 is narrower than the diameter of post 28 such that the bolt works body 33 rests on a top portion of post 28. Flange 36 extends downwardly from bolt works body 33 on one side thereof and slidingly contacts inner wall 15. A tip 38 of locking bolt 22 contacts an edge of bolt works body 33 in the blocking position (as best seen in FIG. 5), which prevents the flange 36 of bolt works 32 from moving or sliding along the inner wall 15 to the unlocked position.

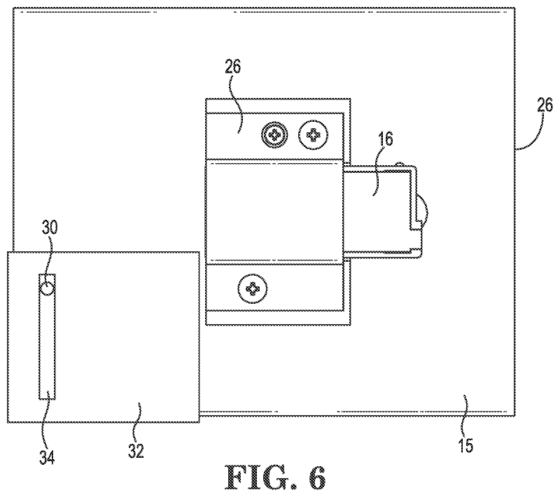

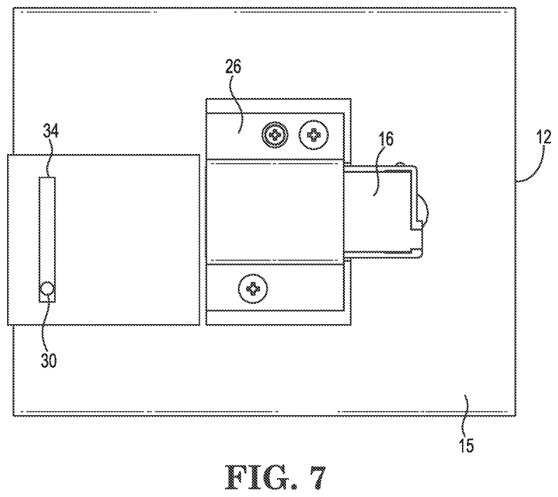

As can be seen in FIG. 5 the locking bolt is in the blocking position with the tip contacting the edge of bolt works 32 maintaining it in the locked position. When a user enters an authorized code electronic means 16 sends a signal to the locking bolt 22 causing it to retract into the housing as best seen in FIG. 6 in which the locking bolt 22 is in the non-blocking position and the bolt works 32 is ready to be moved into the unlocked position. As the user turns the handle (not shown) on the outside of the container door, the bolt works 32 moves to the unlocked position as shown in FIG. 7. When a user has finished accessing the contents of the container, the user again turns the handle which causes the bolt works 32 to start to retract to the locked position while the locking bolt 22 exits the housing 26 and again assumes the blocking position shown in FIG. 5.

Similarly, a user can insert a key into the keyed cylinder causing the locking bolt 22 to retract into the housing 26. The user may then turn the handle (not shown) on the outside of the container door. As the user turns the handle the bolt works 32 moves to the unlocked position. When a user has finished accessing the contents of the container, the user again turns the handle which causes the bolt works 32 to start to retract to the locked position. As the key is turned to the locking position, the locking bolt 22 exits the housing 26 and again assumes the blocking position shown in FIG. 5

Although the present invention has been described with reference to certain aspects and embodiments, those of ordinary skill in the art will appreciate that changes may be made in form and detail without departing from the spirit and scope of the invention.

I claim:

1. A lock system comprising:
a container having a door with an inner wall and an outer wall defining a wall volume therebetween;
a locking bolt including a tip;
a housing mounted to the inner wall, the housing for receiving the locking bolt, the locking bolt movable between a blocking position and a non-blocking position;
a post mounted on the inner wall;
a bolt works having an elongate slot there on, the elongate slot slidingly received by the post and configured to allow the bolt works to move between a locked position and an unlocked position,
wherein in the blocking position, the tip of the locking bolt contacts the bolt works and blocks the bolt works from moving to the unlocked position and in the non-blocking position the locking bolt retracts into the housing and allows the bolt works to move from the locked position to the unlocked position.

2. The lock system of claim 1 wherein the locking bolt is a rotary locking bolt.

3. The lock system of claim 1 further comprising a dial having an electronic key pad thereon.

4. The lock system of claim 3 wherein upon entry of an authorized code a signal is transmitted to the locking bolt causing it to move to the non-blocking position.

5. The lock system of claim 1 further comprising a keyed cylinder for inserting a key and configured to cause the locking bolt to move to the non-blocking position.

6. The lock system of claim 1 wherein the bolt works is L-shaped in cross section and includes a bolt works body and a downwardly extending flange.

7. The lock system of claim 6 wherein the bolt works body includes the elongate slot thereon.

7. The lock system of claim 9 wherein the flange slidingly contacts the inner wall of the container.

8. The lock system of claim 1 wherein the post includes a collar projecting therefrom.

9. The lock system of claim 1 including a redundant entry system.

10. The lock system of claim 9 wherein the redundant entry system includes manual means and electronic means.

11. The lock system of claim 10 wherein the manual means is a keyed lock.

12. The lock system of claim 10 wherein the electronic means is a dial having an electronic keypad configured to transmit an electronic signal to the locking bolt to move it from a blocking position to a non-blocking position.
